(19) United States
(12) Patent Application Publication
(10) Pub. No.: US 2025/0338065 A1
(43) Pub. Date: Oct. 30, 2025

(54) ADJUSTABLE AUDIO FILTERING CIRCUITRY

(71) Applicant: Texas Instruments Incorporated, Dallas, TX (US)

(72) Inventors: Sree Nilendra Gadre, Hyderabad (IN); Vallabha Vasant Hampiholi, Bangalore (IN); Jasjot Singh Chadha, Allen, TX (US)

(21) Appl. No.: 19/067,491

(22) Filed: Feb. 28, 2025

Related U.S. Application Data
(60) Provisional application No. 63/639,015, filed on Apr. 26, 2024.

(51) Int. Cl. H04R 3/04; H04R 29/00

(52) U.S. Cl. CPC H04R 3/04; H04R 29/001; H04R 2430/01

(57) ABSTRACT

Apparatus includes a filter, band filter circuitry, and a controller. The controller is coupled to the filter and the band filter circuitry. The filter attenuates a portion of an audio signal based on a cutoff frequency. The band filter circuitry separates the audio signal into a low frequency band, a mid frequency band, and a high frequency band. The controller adjusts the cutoff frequency of the filter based on a ratio of energies for two of the frequency bands of the audio signal and based on a model of a human perception of audio.

### CROSS-REFERENCE TO RELATED APPLICATION

This patent application claims the benefit of and priority to U.S. Provisional Patent Application No. 63/639,015 filed Apr. 26, 2024, which is hereby incorporated herein by reference in its entirety.

### TECHNICAL FIELD

This description relates generally to computing devices, and, more particularly, to adjustable audio filtering circuitry.

### BACKGROUND

A computing device, such as a laptop, a tablet, a cell phone, etc., may include a battery to power the computing device. The computing device may also include one or more speakers to output audio generated by a processing unit or an application. The battery can provide power to an amplifier which drives the speaker to output the audio. The louder the audio output by the speaker, the more power is drawn from the battery.

### SUMMARY

An example apparatus includes a filter, band filter circuitry, and a controller. The controller is coupled to the filter and the band filter circuitry. The filter attenuates a portion of an audio signal based on a cutoff frequency. The band filter circuitry separates the audio signal into a low frequency band, a mid frequency band, and a high frequency band. The controller adjusts the cutoff frequency of the filter based on a ratio of energies for two of the frequency bands of the audio signal and based on a model of a human perception of audio.

An example system includes a battery, a processor, a first filter, a second filter, a speaker, and a controller. The processor outputs an audio signal. The first filter splits the audio signal into a first band and a second band. The second filter filters the audio signal based on a cutoff frequency. The speaker configured to outputs the filtered audio signal. The controller determines a first characteristic of the first band and a second characteristic of the second band and adjusts the cutoff frequency responsive to a comparison of the first characteristic and the second characteristic.

Example instructions cause one or more programmable circuits to determine a characteristic of a speaker. The example instructions adjust a cutoff frequency of a filter responsive to a comparison of the characteristic of the speaker.

### BRIEF DESCRIPTION OF THE DRAWINGS

FIG. 1 is an example computing device including adjustable audio filtering circuitry.

FIG. 2 is a block diagram of an example of the adjustable audio filtering circuitry, amplifier circuitry, and speaker of FIG. 1, and illustrating an expanded diagram of the audio filtering circuitry.

FIG. 3 illustrates a flowchart representative of example machine readable instructions or example operations that may be executed, instantiated, or performed by example programmable circuitry or digital circuitry to implement the adjustable audio filtering circuitry, or particularly the filter controller of FIG. 2.

FIGS. 4A-4B illustrate a flowchart representative of example machine readable instructions or example operations that may be executed, instantiated, or performed by example programmable circuitry or digital circuitry to implement the adjustable audio filtering circuitry, or particularly the filter controller of FIG. 2.

FIG. 5A illustrates an example graph corresponding to human perception of audio at different frequencies.

FIG. 5B illustrates an example graph corresponding to power savings corresponding to examples described herein.

FIGS. 5C-1 and 5C-2 illustrates an example comparison of power usage based on adjustable audio filtering and static audio filtering.

FIG. 6 is a block diagram of an example processing platform including programmable circuitry structured to execute, instantiate, or perform the example machine readable instructions or perform the example operations of FIGS. 3 and 4A-4B to implement the adjustable audio filtering circuitry, or particularly the filter controller of FIG. 2.

FIG. 7 is a block diagram of an example software/firmware/instructions distribution platform (e.g., one or more servers) to distribute software, instructions, or firmware (e.g., corresponding to the example machine readable instructions of FIGS. 3 and 4A-4B) to client devices associated with end users or consumers (e.g., for license, sale, or use), retailers (e.g., for sale, re-sale, license, or sub-license), or original equipment manufacturers (OEMs) (e.g., for inclusion in products to be distributed to, for example, retailers or to other end users such as direct buy customers).

The same reference numbers or other reference designators are used in the drawings to designate the same or similar (functionally or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines or boundaries may be idealized. In reality, the boundaries or lines may be unobservable, blended or irregular.

Computing devices may include or be connected to speakers (e.g., via a wired or wireless connection) to output audio. For example, a computing device uses current to drive a speaker. The harder the computing device drives a speaker (also referred to as a transducer), the more power the computing device consumes from a power source. Driving some speakers (e.g., small, thin, slim, etc., speakers) can be inefficient. For example, a computing device that drives some speakers draws high currents from the battery responsive to the speakers being pushed to their physical limits. Such speakers are typically least efficient in the low and high frequency regions corresponding to bass and treble. Accordingly, the computing device uses more current from a battery to increase the gain of the low band (e.g., associated with low frequency audio or bass) or high band (e.g., associated with high frequency audio or treble) of an audio signal than the amount of current used to increase the gain of the mid band of the audio signal.

The acoustic sound pressure level (SPL) of some speakers is low for the low band frequency content, high for the mid band frequency content, and medium for the high band frequency content. Accordingly, some computing devices equalize an audio signal by increasing the gain for the low band frequencies, decreasing the gain for the mid band frequencies, and utilizing moderate gain for the high band frequencies. However, as described above, due to the increased power consumption by speakers emitting low band and high band frequencies makes the system less efficient resulting in higher current being drawn from the battery or other power source. Some techniques include using one or more static filters to attenuate low or high frequency signals before those signals reach the speaker, thereby conserving power. However, such techniques affect the audio quality (e.g., bass, loudness, dynamic range, etc.) adversely at all audio levels.

Although filtering the audio signal prior to the speaker conserves power by allowing the computing device to draw less current, filtering the signal affects audio quality adversely at all audio levels. However, the human car may not be capable of detecting the change to the audio quality response to particular characteristics of the audio. For example, as the gain of the signal in human perceptible region increases, the frequencies in low frequency region need lesser gain to be perceived compared to low power levels. For example, at higher loudness (e.g., 100 Phon), a 100 hertz (Hz) audio signal may need to be boosted by 6 decibels (dB) to be perceived at a similar loudness as a 1 kiloHertz (KHz) audio signal. At a lower loudness (40 Phon) the 100 Hz signal may need to be boosted by 22 dB to be perceived at a similar loudness as a 1 KHz audio signal. As used herein, a Phon is a unit to describe loudness level of a given sound or noise. Also, the psychoacoustic response of a human car is more sensitive to frequencies in the mid band (e.g., 400 Hz to 5 KHz).

Examples described herein leverage a human psychoacoustic model corresponding to human perception of audio to filter an audio signal based on the characteristics of the audio signal or characteristics of a speaker. A psychoacoustic model may include Fletcher Munson curves that define the frequencies of audio that a human can perceive based on the energy levels of the audio signal. For example, when the energy of the mid frequencies is low with respect to the energy of the low frequencies, the human car can perceive low frequency sounds (e.g., audio within 130-180 Hz). However, when the energy of the mid frequency is high with respect to the low frequency, the human car can no longer perceive the low frequency sounds. The psychoacoustic model identifies which frequencies of audio that a human can perceive based on the energy levels of the audio. Accordingly, examples described herein use the loudness of the audio signal and the energies at different bands of the audio signal to adjust the gain of the filter(s) or determine which frequencies the filters attenuate to conserve power while maintaining sufficient audio quality based on the human perception of the audio. In this manner, the computing device can draw less current by filtering out frequency bands that correspond to high current consumption. Even though filtering degrades the audio signal, the psychoacoustic model ensures that the degraded portion of the audio is difficult or impossible to be detected by human cars.

In some examples, the characteristics of the audio signal can be inferred based on the temperature of the voice coil of a speaker. For example, when the speaker is warmed up, the audio playback is limited by a protection algorithm to protection speaker damage. The limited audio playback results in audio bass frequencies that are much harder to hear. Also, as the speaker heats up, the mid band range tends to, based on human perception of audio, dominate the audio signal. Thus, when the speaker is above a particular temperature, the human car may not be able to hear lower or higher frequency audio that can be heard when the temperature of the speaker is below the particular frequency. Accordingly, examples described herein adjust the gain of the filter(s) or the filtering characteristics based on temperature of the speaker. Also, examples described herein can adjust the gain of the filter(s) or filtering characteristics based on battery charge or user preferences. Examples described herein compare the characteristics of the audio signal or the speaker/transducer to one or more thresholds to determine when or how to adjust at least one of cutoff frequencies or gains of the filters. The thresholds are defined by a psychoacoustic model that is based on human perception of the audio. Thus, examples described herein utilize an adjustable audio filter that adjusts the filtering circuitry based on one or more of audio signal characteristics, speaker characteristics, user preferences, battery characteristics, or a psychoacoustic model.

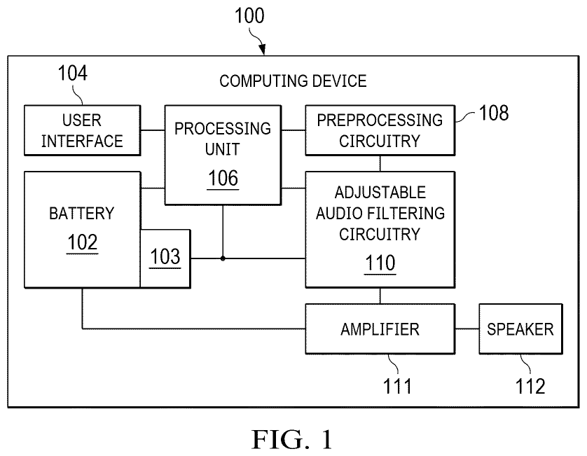

FIG. 1 illustrates an example computing device 100. The computing device 100 of FIG. 1 includes an example battery 102, an example sensor 103, an example user interface 104, an example processing unit 106, example preprocessing circuitry 108, example adjustable audio filtering circuitry 110, an example amplifier 111, and an example speaker 112. The computing device 100 of FIG. 1 may be a computer, a laptop, a television, a cell phone, a tablet, a monitor, a receiver, a set-top-box, or any other type of computing device. Although the example computing device 100 includes all of the components, one or more of the components may be implemented in one or more external devices. For example, the user interface 104, the processing unit 106, or the preprocessing circuitry 108 are implemented in a first device, such as a cell phone, laptop, etc., and the adjustable audio filtering circuitry 110 or the speaker 112 may be implemented in a second device, such as headphones, wireless speakers, etc. Also, one or more of the components of the computing device 100 may be removed or combined. Also, additional components may be added to the computing device 100.

The battery 102 of FIG. 1 is a source of electrical power (e.g., providing voltage and current) including one or more electrochemical cells to power the components of the computing device 100. The battery 102 may be a rechargeable battery or non-rechargeable battery. As the battery 102 powers the computing device 100, the amount of energy that the battery 102 provides depletes. The more current that is drawn from the battery 102, the faster the battery 102 depletes. Responsive to the battery 102 depleting, the voltage provided by the battery 102 may decrease. Although FIG. 1 includes a battery, the battery 102 may be replaced with a power converter that converts AC power from an alternating current (AC) power line to direct current (DC) power. The battery 102 is coupled to the processing unit 106 and the sensor 103.

The sensor 103 of FIG. 1 determines the amount of charge left in the battery 102. For example, the sensor 103 utilizes the voltage or current provided by the battery 102 to determine the amount of charge left in the battery 102. In some examples, the sensor 103 performs a coulomb counting technique to determine the amount of charge left in the battery 102. The coulomb counting technique includes monitoring the charge transferred during the charging and discharging process. However, the sensor 103 can determine the amount of charge of the battery 102 using any charge determination technique. The sensor 103 is coupled to the battery 102 and the adjustable audio filtering circuitry 110. In some examples, the sensor 103 is implemented in the processing unit 106.

The user interface 104 of FIG. 1 interfaces with a user to provide or receive information. For example, the user interface 104 includes one or more of a screen, a touch screen, a keyboard, a microphone, a sensor, a camera, or any other component that can provide or receive information. The user interface 104 is coupled to the processing unit 106.

The processing unit 106 of FIG. 1 performs one or more functions based on applications or instructions. The processing unit 106 may be a central processing unit, a graphical processing unit, a digital signal processor, a microprocessor, a hard drive, a controller, a microcontroller, or any other processing unit. The processing unit 106 provides information, such as text, images, video, prompts, etc., to a user via the user interface 104 and receives information (e.g., user-provided text, input audio, etc.) from the user interface 104. The processing unit 106 may execute or instantiate instructions or applications. The instructions or applications may generate or output an audio signal to be played via the example speaker 112. Accordingly, the processing unit 106 can output an audio signal to the speaker 112 via the preprocessing circuitry 108 or the adjustable audio filtering circuitry 110. Also, the processing unit 106 can provide information received via the user interface 104 to the adjustable audio filtering circuitry 110. The processing unit 106 is coupled to the battery 102, the sensor 103, the user interface 104, the preprocessing circuitry 108, or the adjustable audio filtering circuitry 110.

The preprocessing circuitry 108 of FIG. 1 adjusts the audio signal from the processing unit 106 to optimize the audio signal. For example, the preprocessing circuitry 108 improves quality, adds effect, changes properties, etc. In some examples, the preprocessing circuitry 108 includes a sound card. The preprocessing circuitry 108 receives the audio signal from the processing unit 106, adjusts the audio signal, and passes the adjusted audio signal to the adjustable audio filtering circuitry 110. The preprocessing circuitry 108 is coupled to the processing unit 106 and the adjustable audio filtering circuitry 110.

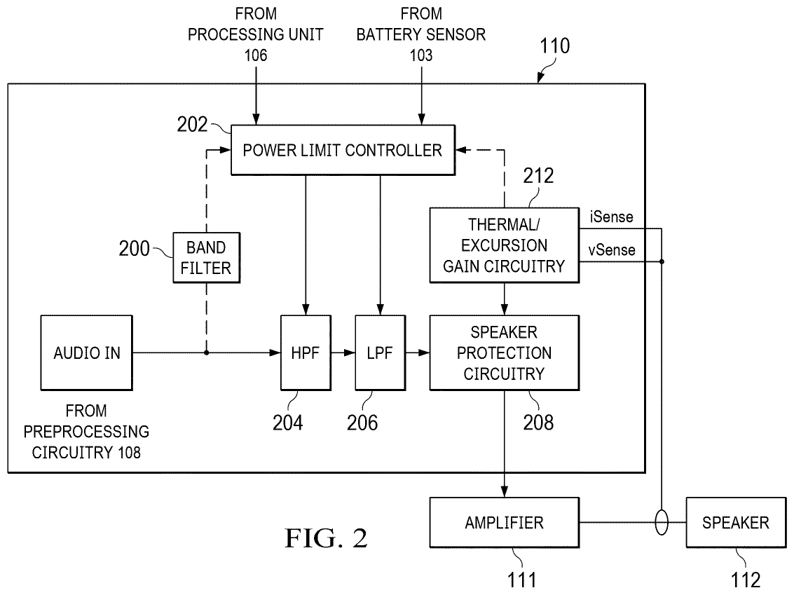

The adjustable audio filtering circuitry 110 of FIG. 1 filters the audio signal provided by the preprocessing circuitry 108 based one or more of the charge of the battery 102, user preferences, characteristics of the audio signal, such as energy levels at different bands of the audio signal, volume of the audio signal, etc., characteristics of the speaker 112, such as temperature of the speaker 112, or based on a psychoacoustic model. For example, the adjustable audio filtering circuitry 110 includes at least one filter (e.g., a high-pass filter and a low-pass filter) with a tunable cutoff frequency and tunable gain. The adjustable audio filtering circuitry 110 compares characteristics of at least one of the audio signal or the speaker 112 to one or more thresholds to determine how to adjust at least one of the cutoff frequency or gain of the one or more filters. The one or more thresholds and the amount of adjustment of at least one of the cutoff frequency or gain of the filter(s) is defined by the psychoacoustic model that includes thresholds and adjustments based on a human perception of audio. The psychoacoustic model may be general or customized to a particular user. For example, the processing unit 106 runs an application to output different audio signals with different characteristics to a user and the user can answer prompts provided via the user interface 104 regarding the user's perception of the audio. Based on the responses, a customized psychoacoustic model can be generated that includes thresholds, frequency cutoff adjustments, and gain adjustments that correspond to the responses of the user. After filtering, the adjustable audio filtering circuitry 110 provides the filtered audio signal to the amplifier 111 to amplify for playback by the speaker 112. The adjustable audio filtering circuitry 110 is coupled to the sensor 103, the processing unit 106, the preprocessing circuitry 108, and the amplifier 111. The adjustable audio filtering circuitry 110 is further described below in conjunction with FIG. 2.

The amplifier 111 of FIG. 1 includes a first terminal coupled to the adjustable audio filtering circuitry 110, a second terminal coupled to the speaker 112, and a third terminal coupled to the battery 102. The amplifier 111 is powered by the battery 102 and amplifies the audio signal output by the adjustable audio filtering circuitry 110 to a particular level so that the audio corresponding to the audio signal can be properly output by the speaker 112. In an example, the amplifier 11 is a Class-D amplifier.

The speaker 112 of FIG. 1 plays audio based on a received audio signal from the amplifier 111. For example, if the audio signal corresponds to music or speech, the speaker 112 converts the audio signal into the music or speech and output the music or speech to a user.

FIG. 2 includes an example implementation of the adjustable audio filtering circuitry 110 of FIG. 1. The adjustable audio filtering circuitry 110 of FIG. 2 includes an example band filter 200, an example filter controller 202, example filters 204, 206, example speaker protection circuitry 208, and example thermal/excursion gain circuitry 212. FIG. 2 further includes the amplifier 111 and the speaker 112 of FIG. 1.

The band filter 200 of FIG. 2 includes a first terminal coupled to the preprocessing circuitry 108 and the first filter 204 and a second terminal coupled to the filter controller 202. The band filter 200 receives an audio signal from the processing unit 106 (e.g., via the preprocessing circuitry 108). The band filter 200 separates (e.g., splits) the audio signal into different frequency bands. For example, the band filter 200 separates (e.g., split) an audio signal into a low band signal (e.g., corresponding to bass or frequencies below a first threshold (300 Hz)), a mid-band signal (e.g., corresponding to mid or frequencies between the first threshold (300 Hz) and a second threshold (4 kHz)), and a high band signal (e.g., corresponding to treble or frequencies above the second threshold (4 kHz)). The band filter 200 provides the bands of the audio signal to the filter controller 202.

The filter controller 202 of FIG. 2 includes a first terminal coupled to the filter 200, a second terminal coupled to the processing unit 106, a third terminal coupled to the battery sensor 103, a fourth terminal coupled to the thermal excursion gain circuitry 212, a fifth terminal coupled to the first filter 204 and a sixth terminal coupled to the second filter 206. The filter controller 202 determines at least one of the cutoff frequencies or gains to apply to the first and second filters 204, 206 based on characteristics of the audio signal, characteristics of the speaker 112, user preferences, battery information, or a psychoacoustic model. As described above, the psychoacoustic model defines which frequencies that a human car can perceive based on the energies of audio. The psychoacoustic model identifies threshold(s), frequency cutoff adjustments, or gain adjustments of the filter(s) based on the characteristics of the audio signal or speaker 112. The psychoacoustic model may be a generalized model with generated thresholds, frequency cutoff adjustments, and gain adjustments of the filter(s) or may be a custom model developed specifically based on the user. For example, a generalized model works for a majority of human hearing. Such a generalized model defines the frequencies of audio that a human can perceive based on the energies of the audio. The custom model may be built by outputting audio with different energy characteristics and prompting the user to identify whether or not they can hear the audio.

The filter controller 202 of FIG. 2 determines the energy levels, in decibel dB units, of the different bands of the audio signal from the band filter 200. In some examples, the filter controller 202 determines the energy level based on a root mean square (RMS) amplitude of the audio signal. After determined, the filter controller 202 generates a first ratio and a second ratio. The first ratio is a ratio of the energy of the mid band (e.g., audio within 300 Hz and 4 kHz) to the energy of the low band (e.g., audio within 20 Hz and 300 Hz). For example, the first ratio is Emid/Elow, where Emid is the energy of the mid band, and Elow is the energy of the low band. The second ratio is a ratio of the energy of the mid band to the energy of the high band (e.g., audio above 4 kHz). For example, the first ratio is Emid/Ehigh, where Emid is the energy of the mid band, and Ehigh is the energy of the high band. In some examples, because power, in Watt units, of the audio signal is a function of the energy of the audio signal (e.g., power is equal to energy over a duration of time), the filter controller 202 determines the power of the different bands of the audio signal and determines the first ratio and the second ratio based on the determined powers. If the first ratio is high (e.g., above 16 dB), a human may not notice a substantial difference responsive to filtering out a larger portion of the lower band. However, doing so decreases the amount of current drawn from the battery 102. Accordingly, the filter controller 202 compares the first ratio to a first threshold (e.g., one of 6 dB, 16 dB, 60 dB, etc., based on the psychoacoustic model), to determine whether to increase the cutoff region in a high-pass filter 204 (e.g., from 130 Hz to 180 Hz), thereby increasing the amount of low band audio signal that is filtered out and increasing power savings. Likewise, if the second ratio is high, a human may not notice a substantial difference responsive to filtering out a larger portion of the high band. However, doing so decreases the amount of current drawn from the battery 102. Accordingly, the filter controller 202 compares the second ratio to a second threshold (e.g., (e.g., 6 dB, 16 dB, 60 dB, etc. based on the psychoacoustic model), to determine whether to decrease the cutoff region of the low-pass filter 206 (e.g., from 20 kHz to 5 kHz), thereby increasing the amount of high band audio signal that is filtered out and increasing power savings. Also, the filter controller 202 can adjust the gain of the high-pass filter 204 or low-pass filter 206 based on the comparison of the ratios to the respective thresholds. The amount of adjustment to the cutoff frequencies or the gains of the filter(s) 202, 204 is defined in the psychoacoustic model.

In some examples, the filter controller 202 of FIG. 2 may also or alternatively adjust one or more of the cutoff frequencies of the corresponding filters 204, 206 based on a temperature of the speaker 112. In such examples, the filter controller 202 receives the speaker temperature from the thermal/excursion gain circuitry 212. The filter controller 202 compares the temperature to a threshold (e.g., defined in the psychoacoustic model) to determine whether to adjust one or more of the cutoff frequencies. The amount of adjustment to the cutoff frequencies is defined in the psychoacoustic model. In some examples, the filter controller 202 does not adjust the cutoff frequency(ies) until a threshold amount of time of the temperature being above a threshold.

The volume of the audio signal may affect the amount of current drawn from the battery 102. For example, at lower volumes, equalizing the low or high band frequencies does not draw a large amount of current. Whereas, at higher volumes, equalizing the low or high band frequencies may draw a disproportionately larger amount of current with respect to equalizing the mid-band frequencies. Accordingly, in some examples, the filter controller 202 may not adjust the cutoff frequencies or may cause the filters 204, 206 to not filter the audio signal responsive to the volume of the audio being below a threshold (e.g., −10 decibels Sound Pressure Level (dBSPL) to 120 dBSPL based on user preferences). The volume may be received from the processing unit 106.

In some examples, the filter controller 202 of FIG. 2 may not adjust the cutoff frequency(ies) or gains (or may adjust less aggressively) of the filter(s) 202, 204 based on the charge of the battery 102. For example, responsive to the battery 102 being fully charged, charged more than a threshold, or being charged by an external device, the filter controller 202 does not adjust the cutoff frequency(ies) or gains of the filter(s) 202, 204 because there is plenty of charge available. In some examples, the filter controller 202 may be more aggressive in the adjusting of at least one of the cutoff frequencies or gains of the filter(s) 202, 204 responsive to the amount of charge from the battery 102 being below a threshold (e.g., for low power mode). The filter controller 202 receives the amount of charge of the battery 102 from the battery sensor 103 of FIG. 1.

In some examples, the filter controller 202 of FIG. 2 can consider user preferences responsive to adjusting at least one of the frequency cutoffs or gain(s) of the filter(s) 202, 204. For example, the filter controller 202 overrides the thresholds or frequency cutoff adjustment values of the psychoacoustic model or set limits on the amount of adjustment. Accordingly, the user can adjust or override the control of the filters 204, 206. The filter controller 202 may be implemented by any combination of hardware (e.g., digital logic circuitry), software, or firmware.

The first filter 204 of FIG. 2 is a high-pass filter that includes a first terminal coupled to the preprocessing circuitry 108 and the band filter 200, a second terminal coupled to the filter controller 202, and a third terminal coupled to the second filter 206. The first filter 204 is a high-pass filter that filters out frequencies of the audio signal below a cutoff frequency. The first filter 204 also applies a gain or attenuation to the audio signal. The cutoff frequency and gain or attenuation are based on one or more control signal from the filter controller 202. The first filter 204 provides the filtered audio signal to the second filter 206.

The second filter 206 of FIG. 2 is a low-pass filter that includes a first terminal coupled to the first filter 204, a second terminal coupled to the filter controller 202, and a third terminal coupled to the speaker protection circuitry 208. The second filter 206 is a low-pass filter that filters out frequencies of the audio signal above a cutoff frequency. The second filter 206 also applies a gain/attenuation to the audio signal. The cutoff frequency and gain/attenuation are based on a control signal from the filter controller 202. The second filter 206 provides the filtered audio signal to the speaker protection circuitry 208. In some examples, the order of the filters 204, 206 may be flipped. In some examples, the first and second filters 204, 206 may be included in the same circuitry, such as a filter that includes the first filter 204 and the second filter 206. In some examples, the first and second filters 204, 206 can be replaced with a single bandpass filter.

The speaker protection circuitry 208 of FIG. 2 includes a first terminal coupled to the second filter 206, a second terminal coupled to the amplifier 111, and a third terminal coupled to the thermal/excursion gain circuitry 212. The speaker protection circuitry 208 can adjust the filtered signal from the second filter 206 to ensure that the signal will not cause damage to the speaker 112 based on the thermal/excursion information determined by the thermal/excursion gain circuitry 212, as further described below. For example, the speaker protection circuitry 208 adjusts the filtered signal to ensure that the filtered signal will not cause the speaker 112 to operate outside of its maximum capabilities. The speaker protection circuitry 208 provides the audio signal to the amplifier 111.

The thermal/excursion gain circuitry 212 of FIG. 2 includes a first terminal coupled to the amplifier 111 and a second terminal coupled to the speaker protection circuitry 208. The thermal/excursion gain circuitry 212 receives current and voltage measurements from the measurement circuitry 214. In some examples, the thermal/excursion gain circuitry 212 includes one or more analog-to-digital converters to convert the analog Vsense or Isense signals into digital signals. The thermal/excursion gain circuitry 212 determines the temperature of the speaker 112 based on the received current and voltage. The thermal/excursion gain circuitry 212 compares the determined temperature to one or more thresholds to determine if the gain of the filter(s) 202, 204 needs to be adjusted to lower the temperature of speaker 112. The thermal/excursion gain circuitry 212 provides the gain to the speaker protection circuitry 208. Also, the thermal/excursion gain circuitry 212 provides the determined temperature to the filter controller 202. If the thermal/excursion gain circuitry 212 is not implemented, the filter controller 202 may receive the voltage and currents from the measurement circuit directly and determines the temperature based on (a) the voltage and current measurements or (b) temperature measurements from one or more temperature sensors in or near the amplifier.

The amplifier 111 of FIG. 2 includes a first terminal coupled to the amplifier 111, a second terminal coupled to the thermal/excursion gain circuitry 212, and a third terminal coupled to the speaker 112. The amplifier 111 amplifies the audio signal output by the speaker protection circuitry 208 to a particular level so that the audio corresponding to the audio signal can be properly output by the speaker 112.

The output of the amplifier circuitry 111 is also coupled to measurement circuitry 214. In an example, the measurement circuitry 214 generates both a VSENSE signal that represents the voltage of the output audio signal and an ISENSE signal that represents the current of the audio going signal. In other examples, the measurement circuitry 214 generates either the VSENSE signal or the ISENSE signal. The measurement circuitry 214 may include any suitable components and use any suitable technique to generate the VSENSE signal and ISENSE signals. In some examples, the measurement circuitry 214 is referred to as IV sense circuitry.

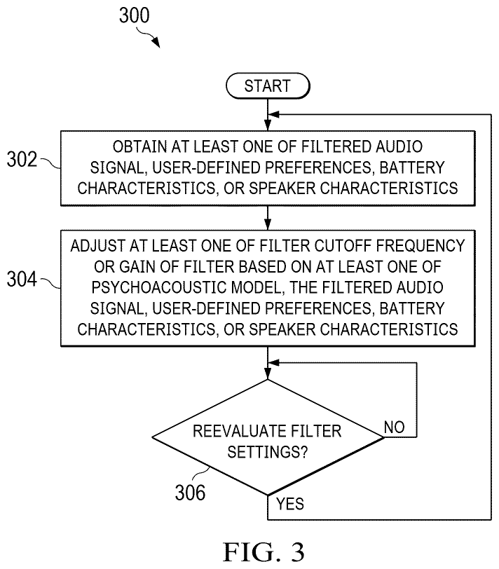

FIG. 3 is a flowchart representative of example machine-readable instructions or example operations 300 that may be at least one of executed, instantiated, or performed by programmable circuitry to adjust at least one of cutoff frequencies or gains of one or more of the filters 204, 206 of FIG. 2. The example machine-readable instructions or the example operations 300 of FIG. 3 begin at block 302, at which the filter controller 202 receives at least one of the filtered audio signal (e.g., via the band filter 200), the user-defined preferences (e.g., via the processing unit 106), the battery characteristics (e.g., via the battery sensor 103), or the speaker characteristics (e.g., via the thermal/excursion gain circuitry 212).

At block 304, the filter controller 202 adjusts at least one of the filter cutoff frequency or the gain of at least one of the filters 204, 206 based on at least one of a psychoacoustic model, the filtered audio signal, the user-defined preferences, the battery characteristics, or the speaker characteristics. As described above, the psychoacoustic model defines at least one of thresholds, gain amounts, or cutoff frequency adjustments to make based on characteristics of the at least one of the audio signal, the battery, or the speaker. At block 306, the filter controller 202 determines whether to reevaluate the filter settings 306. For example, the filter controller 202 reevaluates the filter settings, periodically, aperiodically, or based on a trigger, such as a change in the characteristics, user-prompted trigger, etc. If the filter controller 202 determines that it is not time to reevaluate the filter settings (block 306: NO), control returns to block 306. If the filter controller 202 determines that it is time to reevaluate the filter settings (block 306: YES), control returns to block 320.

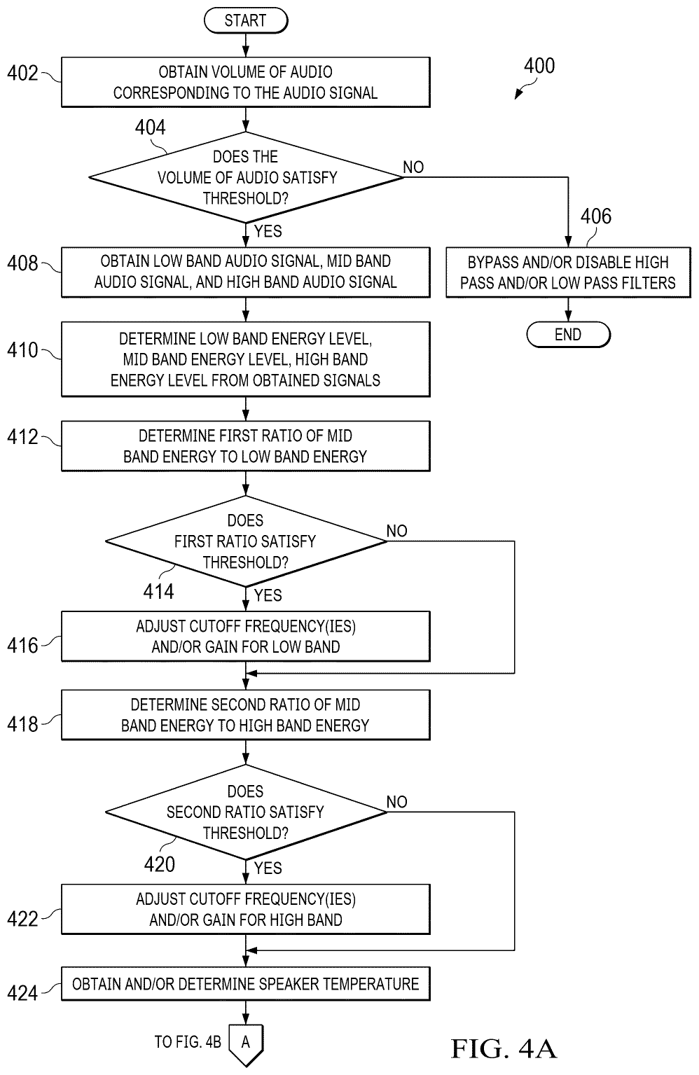

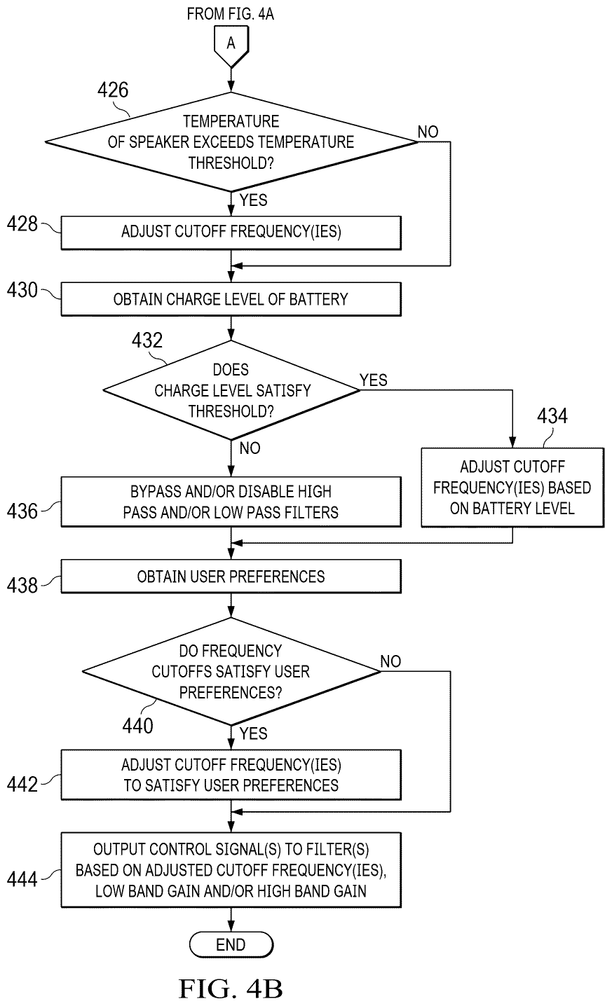

FIGS. 4A and 4B include a flowchart representative of example machine-readable instructions or example operations 400 that may be at least one of executed, instantiated, or performed by programmable circuitry to adjust cutoff frequencies or gains of one or more of the filters 204, 206 of FIG. 2. The example machine-readable instructions or the example operations 400 of FIG. 4 begin at block 402, at which the filter controller 202 receives, from the processing unit 106, an indication of a volume level (also referred to as a loudness level) for the audio signal when output by the speaker 112.

At block 404, the filter controller 202 determines if the volume satisfies (e.g., is above) a threshold volume (e.g., a volume between −10 dBSPL to 120 dBSPL, based on user preferences). If the filter controller 202 determines that the volume does not satisfy (e.g., is not above) the threshold voltage (block 404: NO), the filter controller 202 at least one of bypasses or disables the filters 204, 206 (e.g., to not filter the audio signal) (block 406). As described above, the low band and high band frequencies of an audio signal do not begin to draw a significant amount of current until the volume is high (e.g., above the threshold volume). Thus, there is no need to filter the audio signal to conserve power responsive to the volume being below the threshold. If the filter controller 202 determines that the volume satisfies (e.g., is above) the threshold volume (block 404: YES), the filter controller 202 receives the low band signal (e.g., audio signal below 300 Hz), the mid band signal (e.g., audio signal between 300 HZ and 4 kHz), and the high based signal (e.g., audio signal above 4 kHz) from the band filter 200 (block 408). As further described above in conjunction with FIG. 2, the band filter 200 separates the audio signal into a low band signal for the low frequencies, a mid-band signal for the middle frequencies, and a high band signal for the high frequencies.

At block 410, the filter controller 202 determines the low band energy level based on the low band audio signal, the mid band energy level based on the mid band audio signal, and the high band energy level based on the high band audio signal. As described above in conjunction with FIG. 2, the filter controller 202 may determine the energy levels of the respective bands using an RMS amplitude of the respective bands. At block 412, the filter controller 202 determines a first ratio of the midband energy to the low band energy. As further described above in conjunction with FIG. 2, responsive to the first ratio being high, the human car tends to perceive a loss in the low band less than if the ratio is low. Accordingly, a larger portion of the low band can be filtered out without affecting, or minimally effecting, the quality of the audio as perceived by a human. At block 414, the filter controller 202 determines if the first ratio satisfies (e.g., is above) a first threshold. The first threshold is defined in the psychoacoustic model. For example, the threshold is 16 dB or any value between 6 dB and 60 dB based on tuning, speaker characteristics, or a specific psychoacoustic model developed for a particular user.

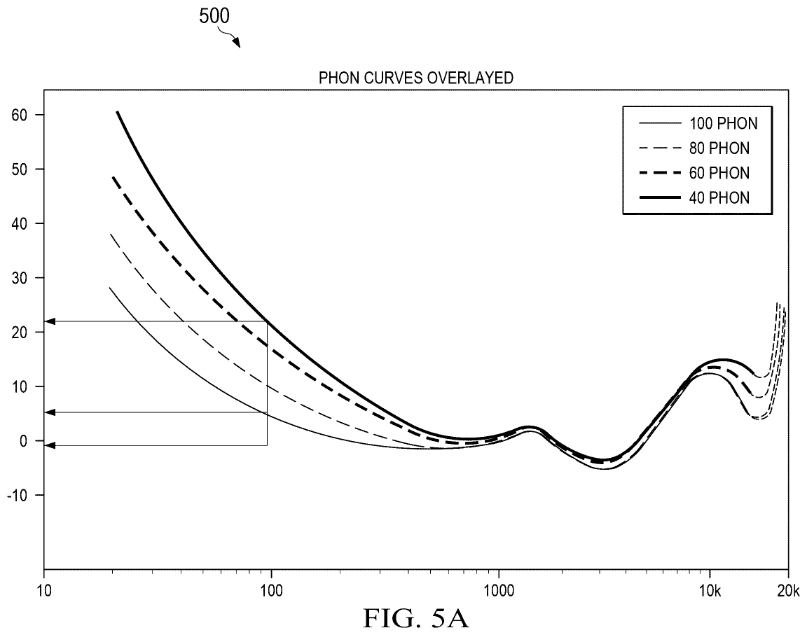

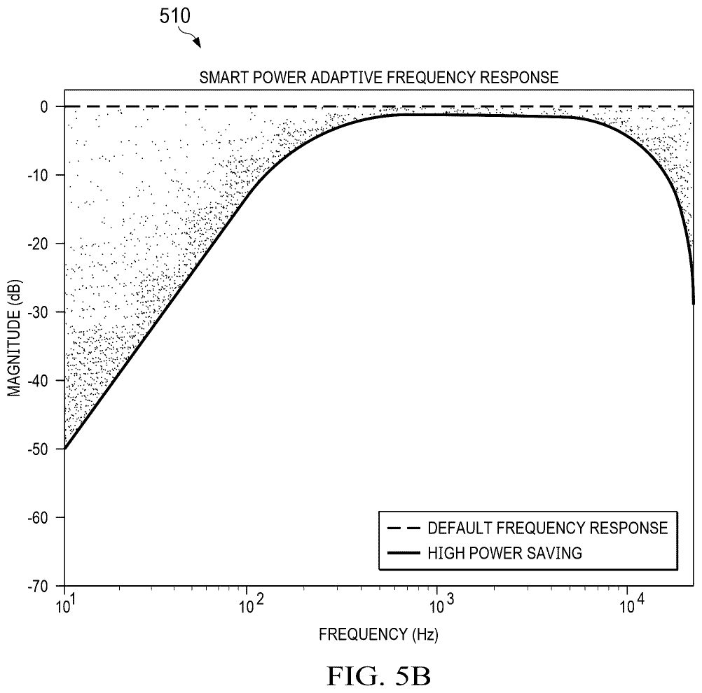

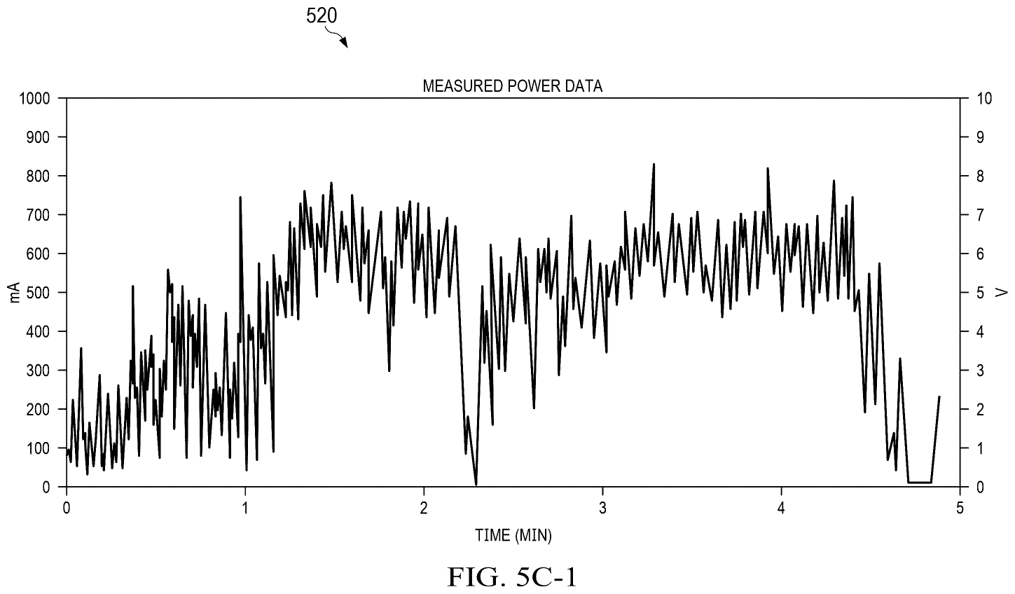

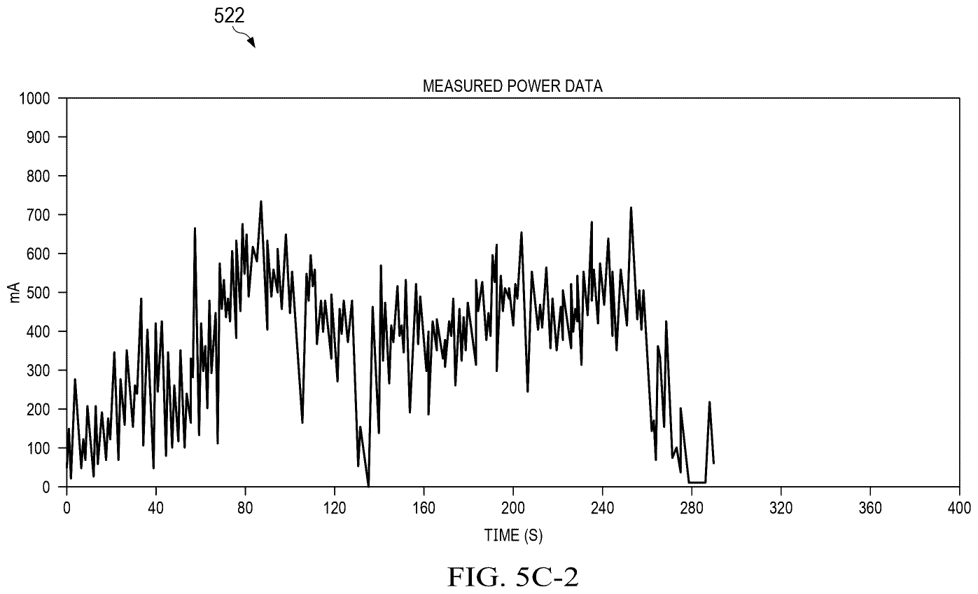

If the filter controller 202 determines that the first ratio satisfies the first threshold (block 414: YES), the filter controller 202 adjusts at least one of the cutoff frequency or the gain of the high-pass filter 204 (block 416). For example, the filter controller 202 adjusts the cutoff frequency of the high-pass filter 204 from 130 Hz to 180 Hz. Also, the gain may be adjusted based on an amount corresponding to the psychoacoustic model. If the psychoacoustic model corresponds to multiple Equal Loudness or Fletcher Munson curves, e.g., as shown in FIG. 5A, the gain adjustment may be based one of the curves. If the filter controller 202 determines that the first ratio does not satisfy the threshold (block 414: NO), instructions continue to block 418. At block 418, the filter controller 202 determines a second ratio of the mid band energy to the high band energy. As further described above in conjunction with FIG. 2, responsive to the second ratio being high, the human ear tends to perceive a loss in the high band less than if the ratio is low. Accordingly, a larger portion of the high band can be filtered out without affecting, or minimally affecting, the quality of the audio as perceived by a human. At block 420, the filter controller 202 determines if the second ratio satisfies (e.g., is above) a second threshold. The second threshold is defined in the psychoacoustic model. For example, the second threshold is 16 dB or any value between 6 dB and 60 dB based on tuning, speaker characteristics, or a specific psychoacoustic model developed for a particular user. If the filter controller 202 determines that the second ratio satisfies the second threshold (block 420: YES), the filter controller 202 adjusts at least one of the cutoff frequency or the gain of the low-pass filter 206 (block 422). For example, the filter controller 202 adjusts cutoff frequency of the low-pass filter 206 from 20 kHz to 5 kHz. Also, the gain may be adjusted based on an amount corresponding to the psychoacoustic model. If the psychoacoustic model corresponds to multiple Equal Loudness or Fletcher Munson curves, the gain adjustment may be based one of the curves. If the filter controller 202 determines that the second ratio does not satisfy the second threshold (block 420: NO), instructions continue to block 424 of FIG. 4B.

At block 424, the example filter controller 202 receives or determines the speaker temperature. For example, the filter controller 202 receives the temperature of the speaker 112 from the thermal/excursion gain circuitry 212. In some examples, the filter controller 202 can determine the speaker temperature based on a current and voltage measurement from the amplifier 111. At block 426, the filter controller 202 determines if the temperature of the speaker 112 exceeds a temperature threshold. For example, the filter controller 202 determines if the sum of the speaker temperature and a buffer value has satisfied (e.g., is higher than) a threshold temperature for more than a threshold duration of time. The threshold temperature may be based on at least one of the psychoacoustic model or user/manufacturer preferences. The buffer (also referred to as delta) is a user defined value to customize what the maximum temperature can be to trigger an adjustment of the cutoff frequencies. In some examples, the delta is zero, so that the comparison to the temperature threshold is performed using just the determined or measured temperature associated with the speaker.

As described above in conjunction with FIG. 2, the temperature of the speaker corresponds to an energy of the bands of the audio signal. Accordingly, the higher the temperature is, the more the filters can filter without negatively affecting a human's perception of the audio. If the filter controller 202 determines that the sum of the speaker temperature and the buffer value has not satisfied the threshold temperature for more than a threshold duration of time (block 426: NO), control continues to block 430. If the filter controller 202 determines that the sum of the speaker temperature and the buffer value satisfies the threshold temperature for more than a threshold duration of time (block 426: YES), the filter controller 202 adjusts at least one of the cutoff frequency of the high pass filter 204 or the cutoff frequency of the low pass filter 206 (block 428). The amount of adjustment is defined by the psychoacoustic model. For example, the filter controller 202 adjusts the cutoff frequency of the high-pass filter 204 from 130 Hz to 180 Hz and may adjust low cutoff frequency of the low-pass filter 206 from 20 kHz to 5 kHz.

At block 430, the filter controller 202 receives the charge left on the battery from the battery sensor 103. At block 432, the filter controller 202 determines whether the charge level of the battery satisfies (e.g., is less than) a threshold. The threshold may be based on the type of battery and user or manufacturer preferences. For example, the threshold is 2.8 Volts to 18 Volts depending on the type of battery used. If the filter controller 202 determines that the charge level satisfies the threshold (block 432: YES), the filter controller 202 adjusts the cutoff frequency of the high pass filter 204 and the cutoff frequency of the low pass filter 206 based on the battery level (block 434). For example, the filter controller 202 adjusts the cutoff frequency of the high-pass filter 204 from 130 Hz to 180 Hz and may adjust cutoff frequency of the low-pass filter 206 from 20 kHz to 5 kHz. If the filter controller 202 determines that the charge level does not satisfy the threshold (block 432: NO), the filter controller 202 at least one of bypasses or disables at least one of the high-pass filter or low-pass filters 204, 206 (block 436). For example, the filter controller 202 disables the cutoff frequencies so that the filters 204, 206 do not filter the audio signal.

At block 438, the filter controller 202 receives user preferences from the processing unit 106. As described above, the user can customize the filtering of the audio signal in any manner, such as setting limits for the cutoff frequencies. At block 440, the filter controller 202 determines if the whether the cutoff frequency(ies) satisfy the user preferences. If the filter controller 202 determines that the cutoff frequency(ies) does not satisfy the user preferences (block 440: NO), control continues to block 444. If the filter controller 202 determines that the filter controller 202 determines that the cutoff frequency(ies) satisfies the user preferences (block 440: YES), the filter controller 202 adjusts at least one of the cutoff frequency of the high pass filter 204 or the cutoff frequency of the low pass filter 206 to satisfy the user preferences (block 442). At block 444, the filter controller 202 provides one or more control signal(s) to the filter(s) 204, 206 based on the adjusted cutoff frequency of the high pass filter 204, the cutoff frequency of the low pass filter 206, the low band gain, or the high band gain causing the filters 204, 206 to adjust the cutoff frequency and gain. Because blocks 428, 434 adjust the cutoff frequencies after the initial adjustment of blocks 416, 422 and the adjustments of block 428, 434 correspond to a higher cutoff frequency for the high pass filter 204 and a lower cutoff frequency for the low pass filter 206, the cutoff frequency for the high pass filter 204 corresponds to the maximum frequency determined by blocks 416, 422, 428, 434. Likewise, the cutoff frequency for the low pass filter 206 corresponds to the minimum frequency determined by blocks 416, 422, 428, 434.

FIG. 5A illustrates an example graph 500 illustrating a loudness level of the audio signal with respect to a frequency of the audio signal. The graph 500 may represent an example loudness/Fletcher Munson curve that can serve as a psychoacoustic model for examples described herein, for example for adjusting filter cutoff frequency threshold values, filter gain values, etc. FIG. 5A includes four plots that correspond to audio signals at different volumes. The graph 500 illustrates that as the input signal loudness (e.g., Phon) increases, humans tend to hear the bass frequency with lesser gain. For example, a high loudness (100 Phon) 100 Hz signal is be gained by 6 dB to be perceived at a similar loudness as a 1 KHz signal. In another example, a low loudness (40 Phon) 100 Hz signal may be gained by 22 dB to be perceived at a similar loudness as a 1 KHz signal. A Phon is a used that described loudness level of a given sound or noise (e.g., audio). The system is based on equal loudness contours, where 0 Phons at 1 KHz is set to 0 dB, the threshold of hearing at the 1 KHz frequency. Accordingly, the graph 500 illustrates that human cars are more sensitive to frequencies in the region of 400 Hz to 5 KHz, as they can perceive these frequencies with similar loudness at all signal levels.

FIG. 5B illustrates an example graph 510 showing the power savings of filtering at different frequencies of the audio signal. Responsive to the battery charge being high, speaker temperature is low, and mid/low ratio and mid/high ratio are low, the output response corresponds to the default response where there is little to no room to save current by filtering. However, responsive to the battery charge being low, speaker temperature is high, and the mid/low ratio and mid/high ratio are high, there is significant room for saving current by adjusting the cutoff frequencies. Accordingly, filtering to increase the high pass cutoff frequency or decrease the low pass cutoff frequency can result in significant power savings.

FIGS. 5C-1 and 5C-2 illustrates a comparison of a first graph 520 of current consumed responsive to outputting an audio signal with a static filter to a second graph 522 of current consumed responsive to outputting the audio signal using the adjustable audio filtering of examples described herein. As shown in the graphs 520, 522, the current savings associated with examples described herein results in 75 mA worth of power savings for the example audio signal without drop or with minimal drop in the perceptual audio quality. For example, the average current for the first graph 520 is approximately 436 mA and the average current for the second graph 522 is approximately 361 mA.

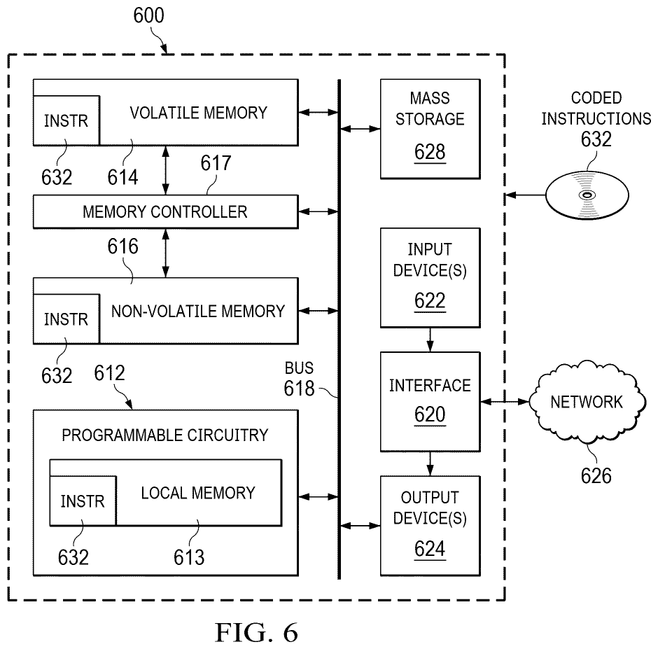

FIG. 6 is a block diagram of an example programmable circuitry platform 600 structured to one or a combination of execute or instantiate one or more of the example machine-readable instructions or the example operations of FIGS. 3, 4A, and 4B to implement the computing device 100 of FIG. 1. The programmable circuitry platform 600 can be, for example, a server, a personal computer, a workstation, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, or microcontrollers from any desired family or manufacturer. The programmable circuitry 612 may be implemented by one or more semiconductor based (e.g., silicon based) devices. In this example, the programmable circuitry 612 implements the filter controller 202.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 616 may be implemented by one or a combination of flash memory or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter one of or a combination of data or commands into the programmable circuitry 612. The input device(s) 622 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 624 are also connected to the interface circuitry 620 of the illustrated example. The output device(s) 624 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 620 of the illustrated example, thus, includes one of or a combination of a graphics driver card, a graphics driver chip, or graphics processor circuitry such as a GPU.

The interface circuitry 620 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store one or more firmware, software, or data. Examples of such mass storage discs or devices 628 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 632, which may be implemented by the machine-readable instructions of FIGS. 3, 4A, and 4B, may be stored in one of or a combination of the mass storage device 628, in the volatile memory 614, in the non-volatile memory 616, or on at least one non-transitory computer readable storage medium such as a CD or DVD which may be removable.

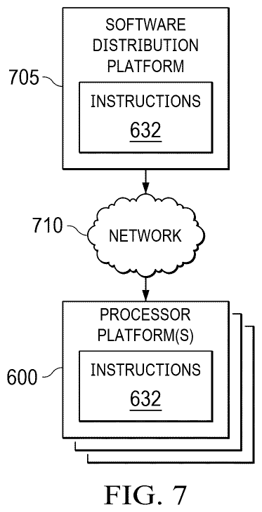

A block diagram illustrating an example software distribution platform 705 to distribute software such as the example machine-readable instructions 632 of FIG. 6 to other hardware devices (e.g., one or more hardware devices owned or operated by third parties from the owner or operator of the software distribution platform) is illustrated in FIG. 7. The example software distribution platform 705 may be implemented by any computer server, data facility, cloud service, etc., capable of storing and transmitting software to other computing devices. The third parties may be customers of the entity at least one of owning or operating the software distribution platform 705. For example, the entity that at least one of owns or operates the software distribution platform 705 may be at least one of a developer, a seller, or a licensor of software such as the example machine-readable instructions 632 of FIG. 6. The third parties may be consumers, users, retailers, OEMs, etc., who one of or a combination of purchase or license the software for at least one of use, re-sale, or sub-licensing. In the illustrated example, the software distribution platform 705 includes one or more servers and one or more storage devices. The storage devices store the machine-readable instructions 632, which may correspond to the example machine-readable instructions of FIGS. 3, 4A, and 4B, as described above. The one or more servers of the example software distribution platform 705 are in communication with an example network 710, which may correspond to any one or more of the Internet or any of the example networks described above. In some examples, the one or more servers are responsive to requests to transmit the software to a requesting party as part of a commercial transaction. Payment for at least one of the delivery, sale, or license of the software may be handled by the one or more servers of at least one of the software distribution platform or by a third-party payment entity. The servers enable one or more purchasers or licensors to download the machine-readable instructions 632 from the software distribution platform 705. For example, the software, which may correspond to the example machine-readable instructions of FIGS. 3, 4A, and 4B, may be downloaded to the example programmable circuitry platform 600, which is to execute the machine-readable instructions 632 to implement the filter controller 202. In some examples, one or more servers of the software distribution platform 705 periodically at least one of offer, transmit, or force updates to the software (e.g., the example machine-readable instructions 632 of FIG. 6) to ensure improvements, patches, updates, etc., are distributed and applied to the software at the end user devices. Although referred to as software above, the distributed “software” could alternatively be firmware.

While an example manner of implementing the adjustable audio filtering circuitry 110 of FIG. 1 is illustrated in FIG. 2, one or more of the elements, processes, or devices illustrated in FIG. 2 may be combined, divided, re-arranged, omitted, eliminated, or implemented in any other way. Further, the filters 200, 204, 206, the filter controller 202, the speaker protection circuitry 208, the thermal/excursion gain circuitry 212, the amplifier 111 of FIG. 2, may be implemented by hardware alone or by hardware in combination with software and firmware. Thus, for example, any of the filters 200, 204, 206, the filter controller 202, the speaker protection circuitry 208, the thermal/excursion gain circuitry 212, the amplifier 111 of FIG. 2, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example filter controller 202 of FIG. 2 may include one or more elements, processes, or devices in addition to, or instead of, those illustrated in FIG. 2, or may include more than one of any or all of the illustrated elements, processes and devices.

Flowchart(s) representative of example machine-readable instructions, which may be executed by programmable circuitry to at least one of implement or instantiate the filter controller 202 of FIG. 2 or representative of example operations which may be performed by programmable circuitry to at least one of implement or instantiate the filter controller 202 of FIG. 2, are shown in FIGS. 3, 4A, and 4B. The machine-readable instructions may be one or more executable programs or portion(s) of one or more executable programs for execution by programmable circuitry such as the programmable circuitry 612 shown in the example processor platform 600 discussed below in connection with FIG. 6 and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., at least one of software or firmware) stored on one or more non-transitory computer readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3, 4A, and 4B, many other methods of implementing the example filter controller 202 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts responsive to being decrypted, decompressed, or combined from a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3, 4A, and 4B may be implemented using executable instructions (e.g., computer readable or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

One or more example manners of implementing the computing device 100 of FIG. 1 is illustrated in FIG. 1 and one or more example manners of implementing the adjustable audio filtering circuitry 110 of FIG. 1 is illustrated in FIG. 2. However, one or more of the elements, processes or devices illustrated in FIG. 1 or 2 may be combined, divided, re-arranged, omitted, eliminated or implemented in any other way.

Further, one or more of the processing unit 106 or the adjustable audio filtering circuitry 110 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) or field programmable logic device(s) (FPLD(s)).

When reading any of the apparatus or system claims of this patent to cover a purely software or firmware implementation, at least one of the processing unit 106 or the adjustable audio filtering circuitry 110 is/are hereby expressly defined to include a non-transitory computer readable storage device or storage disk such as a memory, a digital versatile disk (DVD), a compact disk (CD), a Blu-ray disk, etc., including the software or firmware. Further still, one or more of one or more of the processing unit 106 or the adjustable audio filtering circuitry 110 may include one or more elements, processes or devices in addition to, or instead of, those illustrated in FIGS. 1-2, or may include more than one of any or all of the illustrated elements, processes, and devices. As used herein, the phrase “in communication,” including variations thereof, encompasses direct communication or indirect communication through one or more intermediary components, and does not require direct physical (e.g., wired) communication or constant communication, but rather also includes selective communication at one or more of periodic intervals, scheduled intervals, aperiodic intervals, or one-time events.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein to identify multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for case of understanding the described examples. In some examples, the descriptor “first” may be used to refer to an element in the detailed description, while the same element may be referred to in a claim with a different descriptor such as “second” or “third.” In such instances, such descriptors are used merely for case of referencing multiple elements or components.

In the description and in the claims, the terms “including” and “having,” and variants thereof are to be inclusive in a manner similar to the term “comprising” unless otherwise noted. Unless otherwise stated, “about,” “approximately,” or “substantially” preceding a value means+/−10 percent of the stated value. In another example, “about,” “approximately,” or “substantially” preceding a value means+/−5 percent of the stated value. IN another example, “about,” “approximately,” or “substantially” preceding a value means+/−1 percent of the stated value.

The terms “couple,” “coupled,” “couples,” and variants thereof, as used herein, may cover connections, communications, or signal paths that enable a functional relationship consistent with this description. For example, if device A generates a signal to control device B to perform an action, if a first example device A is coupled to device B, or if a second example device A is coupled to device B through intervening component C if intervening component C does not substantially alter the functional relationship between device A and device B, such that device B is controlled by device A via the control signal generated by device A. Moreover, the terms “couple,” “coupled”, “couples”, or variants thereof, includes an indirect or direct electrical or mechanical connection.

A device that is “configured to” perform a task or function may be configured (e.g., at least one of programmed or hardwired) at a time of manufacturing by a manufacturer to perform the function or may be configurable (or re-configurable) by a user after manufacturing to perform the function or other additional or alternative functions. The configuring may be through at least one firmware or software programming of the device, through a construction or layout of hardware components and interconnections of the device, or a combination thereof.

Although not all separately labeled in the FIG. 2, components or elements of systems and circuits illustrated therein have one or more conductors or terminus that allow signals into or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on particular circuitry or system topology, there may be more or fewer terminals and nodes. However, in some instances, “terminal,” “node,” “interconnect,” “pad,” and “pin” may be used interchangeably.

The term “or” as used, for example, in a form such as A, B, or C refers to any combination or subset of A, B, C such as (1) A alone, (2) B alone, (3) C alone, (4) A with B, (5) A with C, (6) B with C, or (7) A with B and with C.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Example adjustable audio filtering circuitry is described herein. Further examples and combinations thereof include the following: Example 1 includes an apparatus including a filter to attenuate a portion of an audio signal based on a cutoff frequency, band filter circuitry to separate the audio signal into a low frequency band, a mid frequency band, and a high frequency band, and a controller coupled to the filter and the band filter circuitry, and to adjust the cutoff frequency of the filter based on a ratio of energies for two of the frequency bands of the audio signal and based on a model of a human perception of audio.

Example 2 includes the apparatus of example 1, wherein the ratio is of energy of the mid frequency band to energy of the low frequency band, and the filter is a high pass filter.

Example 3 includes the apparatus of example 2, wherein the controller is to compare the ratio to a threshold set based on the model of a human perception of audio, and increase the cutoff frequency of the filter responsive to the ratio exceeding the threshold.

Example 4 includes the apparatus of example 1, wherein the ratio is of energy of the mid frequency band to energy of the high frequency band, and the filter is a low pass filter.

Example 5 includes the apparatus of example 4, wherein the controller is to compare the ratio to a threshold set based on the model of a human perception of audio, and decrease the cutoff frequency of the filter responsive to the ratio exceeding the threshold.

Example 6 includes the apparatus of example 1, wherein the controller is to adjust the cutoff frequency based on a temperature of the speaker.

Example 7 includes the apparatus of example 1, wherein the controller is to adjust the cutoff frequency of the filter based on an amount of charge of a battery.

Example 8 includes the apparatus of example 1, wherein the controller is to adjust the cutoff frequency of the filter based on user preferences.

Example 9 includes the apparatus of example 1, wherein the controller is to adjust a gain of the filter based on the model of a human perception of audio and a volume level of the audio signal.

Example 10 includes the apparatus of example 1, wherein an amount the cutoff frequency is adjusted is based on the model of a human perception of audio.

Example 11 includes a system including a battery, a processor to output an audio signal, first filter circuitry coupled to the processor and to separate the audio signal into a low frequency band, a mid frequency band, and a high frequency band, second filter circuitry to filter the audio signal based on a cutoff frequency, an amplifier coupled to the second filter circuitry, a speaker coupled to the amplifier, and a controller coupled to the first and second filter circuitries, and to determine a ratio of energies for two of the frequency bands of the audio signal, compare the ratio to a threshold that is based on a model of a human perception of audio, and adjust the cutoff frequency responsive to a result of the comparison.

Example 12 includes the system of example 11, wherein the second filter circuitry includes a high pass filter having the cutoff frequency, and the ratio is of energy of the mid frequency band to energy of the low frequency band, and the controller is to increase the cutoff frequency responsive to the ratio exceeding the threshold.

Example 13 includes the system of example 11, wherein the controller is to further adjust the cutoff frequency based on an amount of charge of the battery.

Example 14 includes the system of example 11, wherein the controller is to further adjust the cutoff frequency based on a temperature of the speaker.

Example 15 includes the system of example 11, wherein the second filter circuitry includes a low pass filter having the cutoff frequency, and the ratio is of energy of the mid frequency band to energy of the high frequency band, and the controller is to decrease the cutoff frequency responsive to the ratio exceeding the threshold.

Example 16 includes an apparatus including a high pass filter to attenuate a first portion of an audio signal based on a first cutoff frequency, a low pass filter coupled to the high pass filter and to attenuate a second portion of the audio signal based on a second cutoff frequency, band filter circuitry to separate the audio signal into a low frequency band, a mid frequency band, and a high frequency band, and a controller coupled to the high pass and low pass filters and to the band filter circuitry, and to determine a ratio of energies for two of the frequency bands of the audio signal, compare the ratio to a threshold that is based on a model of a human perception of audio, and adjust the first cutoff frequency or the second cutoff frequency responsive to a result of the comparison.

Example 17 includes the apparatus of example 16, wherein the ratio is of energy of the mid frequency band to energy of the low frequency band, and the controller is to increase the first cutoff frequency of the high pass filter responsive to the ratio exceeding the threshold.

Example 18 includes the apparatus of example 16, wherein the ratio is of energy of the mid frequency band to energy of the high frequency band, and the controller is to decrease the second cutoff frequency of the low pass filter responsive to the ratio exceeding the threshold.

Example 19 includes the apparatus of example 16, wherein the controller is to adjust the first and second cutoff frequencies responsive to a temperature for the speaker exceeding a temperature threshold.

Example 20 includes the apparatus of example 16, wherein the controller is to adjust a gain of the high pass filter or a gain of the low pass filter by an amount based on the model of a human perception of audio and a volume level of the audio signal.

Modifications are possible in the described examples, and other examples are possible, within the scope of the claims.

What is claimed is:

1. An apparatus comprising:
a filter configured to attenuate a portion of an audio signal based on a cutoff frequency;
band filter circuitry configured to separate the audio signal into a low frequency band, a mid frequency band, and a high frequency band; and
a controller coupled to the filter and the band filter circuitry, and configured to adjust the cutoff frequency of the filter based on a ratio of energies for two of the frequency bands of the audio signal and based on a model of a human perception of audio.

2. The apparatus of claim 1, wherein the ratio is of energy of the mid frequency band to energy of the low frequency band, and the filter is a high pass filter.

3. The apparatus of claim 2, wherein the controller is configured to:
compare the ratio to a threshold set based on the model of a human perception of audio; and
increase the cutoff frequency of the filter responsive to the ratio exceeding the threshold.

4. The apparatus of claim 1, wherein the ratio is of energy of the mid frequency band to energy of the high frequency band, and the filter is a low pass filter.

5. The apparatus of claim 4, wherein the controller is configured to:
compare the ratio to a threshold set based on the model of a human perception of audio; and
decrease the cutoff frequency of the filter responsive to the ratio exceeding the threshold.

6. The apparatus of claim 1, wherein the controller is configured to adjust the cutoff frequency based on a temperature of a speaker.

7. The apparatus of claim 1, wherein the controller is configured to adjust the cutoff frequency of the filter based on an amount of charge of a battery.

8. The apparatus of claim 1, wherein the controller is configured to adjust the cutoff frequency of the filter based on user preferences.

9. The apparatus of claim 1, wherein the controller is configured to adjust a gain of the filter based on the model of a human perception of audio and a volume level of the audio signal.

10. The apparatus of claim 1, wherein an amount the cutoff frequency is adjusted is based on the model of a human perception of audio.

11. A system comprising:
a battery;
a processor configured to output an audio signal;
first filter circuitry coupled to the processor and configured to separate the audio signal into a low frequency band, a mid frequency band, and a high frequency band;
second filter circuitry configured to filter the audio signal based on a cutoff frequency;
an amplifier coupled to the second filter circuitry;
a speaker coupled to the amplifier; and
a controller coupled to the first and second filter circuitries, and configured to:
determine a ratio of energies for two of the frequency bands of the audio signal;
compare the ratio to a threshold that is based on a model of a human perception of audio; and
adjust the cutoff frequency responsive to a result of the comparison.

12. The system of claim 11, wherein the second filter circuitry includes a high pass filter having the cutoff frequency, and the ratio is of energy of the mid frequency band to energy of the low frequency band, and the controller is configured to increase the cutoff frequency responsive to the ratio exceeding the threshold.

13. The system of claim 11, wherein the controller is configured to further adjust the cutoff frequency based on an amount of charge of the battery.

14. The system of claim 11, wherein the controller is configured to further adjust the cutoff frequency based on a temperature of the speaker.

15. The system of claim 11, wherein the second filter circuitry includes a low pass filter having the cutoff frequency, and the ratio is of energy of the mid frequency band to energy of the high frequency band, and the controller is configured to decrease the cutoff frequency responsive to the ratio exceeding the threshold.

16. An apparatus comprising:
a high pass filter configured to attenuate a first portion of an audio signal based on a first cutoff frequency;
a low pass filter coupled to the high pass filter and configured to attenuate a second portion of the audio signal based on a second cutoff frequency;
band filter circuitry configured to separate the audio signal into a low frequency band, a mid frequency band, and a high frequency band; and
a controller coupled to the high pass and low pass filters and to the band filter circuitry, and configured to:
determine a ratio of energies for two of the frequency bands of the audio signal;
compare the ratio to a threshold that is based on a model of a human perception of audio; and
adjust the first cutoff frequency or the second cutoff frequency responsive to a result of the comparison.

17. The apparatus of claim 16, wherein the ratio is of energy of the mid frequency band to energy of the low frequency band, and the controller is configured to increase the first cutoff frequency of the high pass filter responsive to the ratio exceeding the threshold.

18. The apparatus of claim 16, wherein the ratio is of energy of the mid frequency band to energy of the high frequency band, and the controller is configured to decrease the second cutoff frequency of the low pass filter responsive to the ratio exceeding the threshold.

19. The apparatus of claim 16, wherein the controller is configured to adjust the first and second cutoff frequencies responsive to a temperature for a speaker exceeding a temperature threshold.

20. The apparatus of claim 16, wherein the controller is configured to adjust a gain of the high pass filter or a gain of the low pass filter by an amount based on the model of a human perception of audio and a volume level of the audio signal.
